(19) United States
(12) Patent Application Publication
(10) Pub. No.: US 2015/0285748 A1
(43) Pub. Date: Oct. 8, 2015

(54) EXAMINATION APPARATUS, METHOD OF EXAMINING SEMICONDUCTOR DEVICE AND MANUFACTURING METHOD OF ELECTRONIC DEVICE

(71) Applicant: Samsung Electronics Co., Ltd., Suwon-si (KR)

(72) Inventors: YOUNGHWAN JANG, Asan-si (KR); JAESOO LEE, Cheonan-si (KR); PYOUNGGWAN KIM, Cheonan-si (KR); Jongshun SHIN, Cheonan-si (KR); KYEOUNGSOO LEE, Asan-si (KR); SOOKUL LEE, Cheonan-si (KR); Seoungsu HA, Cheonan-si (KR)

(21) Appl. No.: 14/595,213

(22) Filed: Jan. 13, 2015

(30) Foreign Application Priority Data
Apr. 7, 2014 (KR) 10-2014-0041150

(51) Int. Cl. G01N 21/95; G01B 11/06

(52) U.S. Cl. CPC G01N 21/9501; G01B 11/0608; G01N 2201/061

(57) ABSTRACT

Provided are an examination apparatus and a method of examining a semiconductor device. The examination apparatus includes a support on which a semiconductor device to be examined is disposed, a light irradiation unit that obliquely emits light at a set angle to the support, an image capturing member configured to capture an image of an upper surface of the support, and a control member configured to determine, based on the image captured by the image capturing member, whether a height of the semiconductor device is standard by using the set angle and an examination pattern formed on the semiconductor device by the light.

### CROSS-REFERENCE TO RELATED APPLICATIONS

This U.S. non-provisional patent application claims priority under 35 U.S.C. §119 of Korean Patent Application No. 10-2014-0041150, filed on Apr. 7, 2014, the entire contents of which are hereby incorporated by reference.

### BACKGROUND

The present disclosure relates to an examination apparatus and a method of examining an object.

Many products need appearance inspection. Appearance examinations may be performed between processes of producing objects or on finished products after all production processes are completed. Appearance examinations may examine the appearance of objects to determine whether the objects have a defect. For example, the appearance of a semiconductor chip is often examined before being released. Accordingly, examination may determine whether letters and/or characters are correctly printed on the surface of the semiconductor chip, whether a foreign substance is attached thereto, and/or whether the surface of the semiconductor chip is damaged.

The appearance of objects may be examined by capturing an image thereof through an imaging apparatus. It may be helpful to sense the thickness of the objects or a variation in the thickness thereof to efficiently examine the appearance of the objects. For example, when an object to be examined is thinner or thicker than a passed product, the object may have a defect. In some occasions, one object may cover another object in an appearance examination so that the other object may not be examined in the examination process.

### SUMMARY

The present disclosure provides an examination apparatus, a method of examining an object and a manufacturing method of an electronic device, which senses a variation in the thickness of the object.

Embodiments of the inventive concept provide examination apparatuses for examining a semiconductor device including: a support on which the semiconductor device to be examined is disposed; a light irradiation unit that obliquely emits light at a set angle to the support; an image capturing member configured to capture an image of an upper surface of the support and an upper surface of the semiconductor device; and a control member configured to sense, based on the image captured by the image capturing member, whether a height of the semiconductor device is substantially the same as a predetermined standard height by using the set angle and an examination pattern formed on the upper surface of the semiconductor device by the light.

The image capturing member may be upwardly spaced a set distance from an upper surface of the semiconductor device to capture a planar image of the semiconductor device.

The light irradiation unit may include a light source disposed in an upper part thereof to emit light, and a pattern forming member disposed under the light source such that the examination pattern may be formed by the light. The light irradiation unit may emit light such that the examination pattern is provided in plurality on the semiconductor device and a region adjacent to the semiconductor device, respectively.

The control member may be configured to sense whether the height of the semiconductor device is substantially the same as the predetermined standard height, based on a first examination pattern formed in the region adjacent to the semiconductor device, a second examination pattern formed on the semiconductor device, and the set angle. The light irradiation unit may emit light to propagate as a parallel ray.

The support may be an auxiliary support, and the control member may be configured to sense whether the height of the semiconductor device is substantially the same as the predetermined standard height by using the set angle, the examination pattern formed on the upper surface of the semiconductor device by the light, and an examination pattern formed on the upper surface of the auxiliary support by the light.

Whether the height of the semiconductor device is substantially the same as the predetermined standard height may be determined based on a distance in a horizontal direction between the examination patterns formed on the upper surface of the semiconductor device by the light, and the examination pattern formed on the upper surface of the auxiliary support by the light.

In other embodiments of the inventive concept, methods of examining a semiconductor device include: disposing the semiconductor device on a support; forming an examination pattern on the semiconductor device by obliquely emitting light at a set angle to the semiconductor device; and using an electronic image capture device, capturing an overhead image of the top surface of the semiconductor device, and using the examination pattern, the overhead image, and the set angle to determine whether a thickness of the semiconductor device corresponds to a standard thickness.

A control member may determine whether the thickness of the semiconductor device corresponds to the standard thickness by using a location of the examination pattern within the overhead image and a set location in which the examination pattern is formed in an overhead image when the thickness of the semiconductor device corresponds to the standard thickness.

A control member may determine whether the thickness of the semiconductor device corresponds to the standard thickness by using an area of the examination pattern and an area of a set pattern formed on the semiconductor device by the light when the thickness of the semiconductor device corresponds to a standard thickness.

The semiconductor device may be disposed on an auxiliary support disposed on the support. A first examination pattern may be formed on the auxiliary support by the light, and a second examination pattern may be formed on the semiconductor device by the light. Whether the thickness of the semiconductor device corresponds to the standard thickness may be determined using the set angle and a relative location of the second examination pattern to the first examination pattern.

Whether the thickness of the semiconductor device corresponds to the standard thickness may be determined using a variation in an area of the first examination pattern and a variation in an area of the second examination pattern.

In other embodiments, methods of manufacturing an electronic device includes steps of forming circuit on a semiconductor substrate, cutting the substrate into plurality of semiconductor chips, packaging one of the chips into a semiconductor package, examining the semiconductor package by using an examination apparatus, and installing the semiconductor package into the electronic device, wherein the examination apparatus includes a support on which the semiconductor package is disposed, a light irradiation unit emitting light obliquely to the support, an image capturing device capturing an image of the semiconductor package and its surroundings, and a control unit that examines whether a height of the semiconductor package is substantially the same as a predetermined standard height based on a location or area of the light on the support.

The control unit may examine whether the height of the semiconductor package is substantially the same as the predetermined standard height comparing a location in a horizontal direction of a light emitted on the semiconductor device to a predetermined location in the horizontal direction.

The light irradiation unit may emit two or more light patterns, a first of the light patterns emitted onto the semiconductor package, a second of the light patterns emitted on the surroundings, and the control unit may examine whether the height of the semiconductor package is substantially the same as a predetermined standard height by comparing the first and the second light patterns.

The first light pattern may be formed from a light transmitted parallel to a light that forms the second light pattern. The light irradiation unit may emit a spreading out light pattern.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain exemplary principles of the inventive concept. In the drawings:

FIG. 1 is a schematic view illustrating an examination apparatus according to an embodiment of the inventive concept;

FIG. 2 is a schematic view illustrating an exemplary configuration of the light irradiation unit illustrated in FIG. 1;

FIG. 3 is a schematic view illustrating a state in which light is emitted to an object to be examined, which is disposed on a support, according to an embodiment of the inventive concept;

FIG. 4 is a plan view illustrating the object of FIG. 3, according to an embodiment of the inventive concept;

FIG. 5 is a schematic view illustrating a state in which light is emitted to an object to be examined, which has a thickness greater than a standard thickness, according to an embodiment of the inventive concept;

FIG. 6 is a plan view illustrating the object of FIG. 5, according to an embodiment of the inventive concept;

FIG. 7 is a schematic view illustrating an examination apparatus in which an object to be examined is disposed on an auxiliary support, according to an embodiment of the inventive concept;

FIG. 8 is a schematic view illustrating a state in which light is emitted to an auxiliary support and an object to be examined, according to an embodiment of the inventive concept;

FIG. 9 is a plan view illustrating the auxiliary support and the object of FIG. 8, according to an embodiment of the inventive concept;

FIG. 10 is a schematic view illustrating a state in which light is emitted to an auxiliary support and an object to be examined which has a thickness greater than a standard thickness, according to an embodiment of the inventive concept;

FIG. 11 is a plan view illustrating the auxiliary support and the object of FIG. 10, according to an embodiment of the inventive concept;

FIG. 12 is a schematic view illustrating a state in which light is emitted to an object to be examined and an auxiliary support having a thickness smaller than a standard thickness, according to an embodiment of the inventive concept;

FIG. 13 is a plan view illustrating the auxiliary support and the object of FIG. 12, according to an embodiment of the inventive concept;

FIG. 14 is a schematic view illustrating a state in which light is emitted to an auxiliary support having a thickness smaller than a standard thickness, and an object to be examined which has a thickness greater than a standard thickness, according to an embodiment of the inventive concept;

FIG. 15 is a plan view illustrating the auxiliary support and the object of FIG. 14, according to an embodiment of the inventive concept;

FIG. 16 is a schematic view illustrating an examination apparatus that emits light, according to an embodiment of the inventive concept;

FIG. 17 is a schematic view illustrating a state in which light is emitted to an object to be examined which is disposed on a support, according to an embodiment of the inventive concept;

FIG. 18 is a plan view illustrating the object of FIG. 17, according to an embodiment of the inventive concept;

FIG. 19 is a schematic view illustrating a state in which light is emitted to an object to be examined which has a thickness greater than a standard thickness, according to an embodiment of the inventive concept;

FIG. 20 is a plan view illustrating the object of FIG. 19, according to an embodiment of the inventive concept;

FIG. 21 is a schematic view illustrating an examination apparatus in which an object to be examined is disposed on an auxiliary support, according to an embodiment of the inventive concept;

FIG. 22 is a schematic view illustrating a state in which light is emitted to an auxiliary support and an object to be examined, according to an embodiment of the inventive concept;

FIG. 23 is a plan view illustrating the auxiliary support and the object of FIG. 22, according to an embodiment of the inventive concept;

FIG. 24 is a schematic view illustrating a state in which light is emitted to an auxiliary support and an object to be examined which has a thickness greater than a standard thickness, according to an embodiment of the inventive concept;

FIG. 25 is a plan view illustrating the auxiliary support and the object of FIG. 24, according to an embodiment of the inventive concept;

FIG. 26 is a schematic view illustrating a state in which light is emitted to an object to be examined and an auxiliary support having a thickness smaller than a standard thickness, according to an embodiment of the inventive concept;

FIG. 27 is a plan view illustrating the auxiliary support and the object of FIG. 26, according to an embodiment of the inventive concept;

FIG. 28 is a schematic view illustrating a state in which light is emitted to an auxiliary support having a thickness smaller than a standard thickness, and an object to be examined which has a thickness greater than a standard thickness, according to an embodiment of the inventive concept; and

FIG. 29 is a plan view illustrating the auxiliary support and the object of FIG. 28, according to an embodiment of the inventive concept.

FIG. 30 is a schematic view illustrating a state in which light is emitted to an object to be examined, which is disposed on a support, according to an embodiment of the inventive concept;

FIG. 31 is a plan view illustrating the object of FIG. 30, according to an embodiment of the inventive concept.

### DETAILED DESCRIPTION OF THE EMBODIMENTS

Exemplary embodiments of the inventive concept will be described below in more detail with reference to the accompanying drawings. The inventive concept may, however, be embodied in different forms and should not be construed as limited to the embodiments set forth herein. Rather, these embodiments are just that—examples—and many implementations and variations are possible that do not require the details provided herein. It should also be emphasized that the disclosure provides details of alternative examples, but such listing of alternatives is not exhaustive. Furthermore, any consistency of detail between various examples should not be interpreted as requiring such detail—it is impracticable to list every possible variation for every feature described herein. The language of the claims should be referenced in determining the requirements of the invention. In the drawings, the shapes and/or sizes of components may be exaggerated for clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “and/or” includes any and all combinations of one or more of the associated listed items and may be abbreviated as “/”.

It will be understood that, although the terms first, second, etc. may be used herein to describe various elements, these elements should not be limited by these terms. Unless indicated otherwise, these terms are only used to distinguish one element from another. For example, a first object could be termed a second object, and, similarly, a second object could be termed a first object without departing from the teachings of the disclosure.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that when an element is referred to as being “connected” or “coupled” to or “on” another element, it can be directly connected or coupled to or on the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). However, the term “contact,” as used herein refers to direct contact (i.e., touching) unless the context indicates otherwise.

Embodiments described herein will be described referring to plan views and/or cross-sectional views by way of ideal schematic views. Accordingly, the exemplary views may be modified depending on manufacturing technologies and/or tolerances. Therefore, the disclosed embodiments are not limited to those shown in the views, but include modifications in configuration formed on the basis of manufacturing processes. Therefore, regions exemplified in figures may have schematic properties, and shapes of regions shown in figures may exemplify specific shapes of regions of elements to which aspects of the invention are not limited.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

Terms such as “same,” “planar,” or “coplanar,” as used herein when referring to orientation, layout, location, shapes, sizes, amounts, or other measures do not necessarily mean an exactly identical orientation, layout, location, shape, size, amount, or other measure, but are intended to encompass nearly identical orientation, layout, location, shapes, sizes, amounts, or other measures within acceptable variations that may occur, for example, due to manufacturing processes. The term “substantially” may be used herein to reflect this meaning.

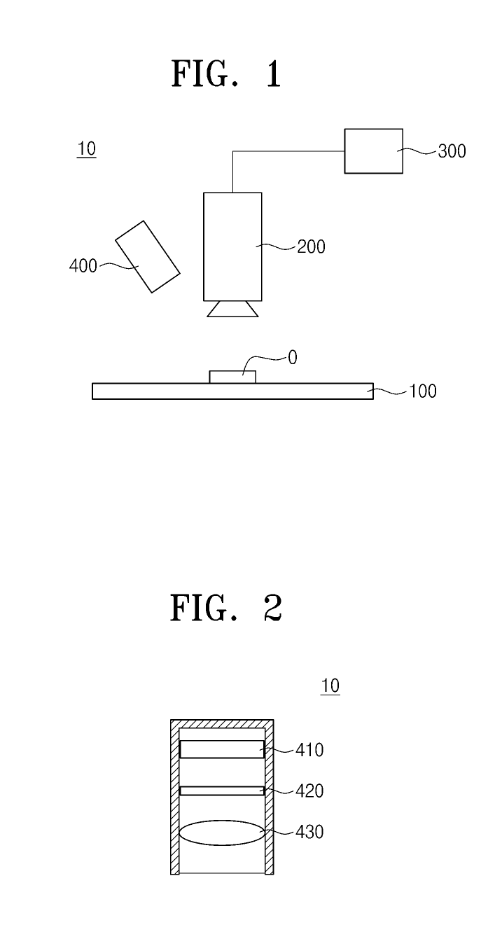

FIG. 1 is a schematic view illustrating an examination apparatus according to an embodiment of the inventive concept.

Referring to FIG. 1, an examination apparatus 10 examines an appearance of an object O. The appearance of the object O may be examined after a predetermined process. For example, the object O may be a semiconductor device including a semiconductor chip or a semiconductor package, an electric product, an electronic product, or a mechanical device. The appearance of the object O, such as a semiconductor device, an electric product, an electronic product, or a mechanical device, may be examined after a predetermined process. At this point, a character or a figure, for example, may have been printed on an outer surface of the object O. The examination apparatus 10 may examine whether a character is correctly printed, whether a foreign substance is attached to the object O, or whether the appearance of the object O is damaged, by examining the appearance of the object O.

The examination apparatus 10 includes a support 100, an image capturing member 200, a control member 300, and a light irradiation unit 400.

The support 100 supports the object O. The support 100 may be provided, for example, as a plate shape having a predetermined area. The object O is examined on an upper surface of the support 100.

The image capturing member 200 captures an image of the upper surface of the support 100. For example, the image capturing member 200 may be provided with an electro-optical device, for example, a camera, a digital camera, a CCD camera, etc., and may include a combination of software, hardware, and/or firmware configured to capture an image. The image capturing member 200 may include a location adjustment function relative to the support 100. For example, the image capturing member 200 may be movable. Alternatively, the support 100 may be movable. Alternatively, the image capturing member 200 and the support 100 may be movable.

The control member 300 receives an image captured by the image capturing member 200. The control member 300 may examine the object O based on the received image. The control member 300 may include circuitry, and may include software, hardware, and/or firmware configured to carry out controlling actions for the examination apparatus 10. The control member 300 may be referred to herein as a controller.

The light irradiation unit 400 obliquely emits light on the upper surface of the support 100. Specifically, the light emitted from the light irradiation unit 400 may be obliquely incident to the support 100 at a set angle from a line perpendicular to the upper surface of the support 100. The light irradiation unit 400 may be attached to the image capturing member 200. Thus, when the image capturing member 200 is movable, the light irradiation unit 400 may be moved together with the image capturing member 200. Alternatively, the light irradiation unit 400 may be separated from the image capturing member 200. In this case, the light irradiation unit 400 may be movable such that a location thereof can be adjusted relative to the image capturing member 200 and the support 100. The light irradiation unit 400 may emit light to a region, an image of which is captured by the image capturing member 200.

An examination pattern A (refer to FIG. 4) is formed on a surface irradiated with the light. The examination pattern A may be, for example, a point, a line, or a figure. The examination pattern A may be formed by light. Specifically, the light irradiation unit 400 may emit light in a shape of a point, a line, or a figure to form the examination pattern A on a surface irradiated with the light. The point, line, or figure may have a known form, so as to be more easily recognizable by the image capturing member 200 and control member 300.

Alternatively, the examination pattern A may be formed by a shadow. Specifically, the light irradiation unit 400 may emit light to a region except for a part corresponding to the examination pattern A to form the examination pattern A on the part on which the light is not emitted.

Alternatively, the examination pattern A may be formed by a difference in brightness, chroma, or color. Specifically, the light irradiation unit 400 may emit light to a region corresponding to the examination pattern A. The light irradiation unit 400 may emit different light to a region surrounding the examination pattern A. The brightness, chroma, or color of the light emitted to the surrounding region may be different from that of the light emitted to the region corresponding to the examination pattern A.

FIG. 2 is a schematic view illustrating an exemplary configuration of the light irradiation unit illustrated in FIG. 1.

Referring to FIG. 2, the light irradiation unit 400 includes a light source 410, a pattern forming member 420, and a lens member 430.

The light source 410 is disposed in the upper part of the light irradiation unit 400 to emit light.

The pattern forming member 420 is disposed under the light source 410 such that light emitted to the support 100 through the pattern forming member 420 forms the examination pattern A. For example, the pattern forming member 420 may change the brightness, chroma, or color of light passing therethrough, according to sections thereof. For another example, the pattern forming member 420 may be provided as a plate having a hole such that light passes through only a part corresponding to the examination pattern A or only a part except for the part corresponding to the examination pattern A.

The lens member 430 is disposed in the lower part of the light irradiation unit 400 to adjust the emitted light. The lens member 430 may be provided as one or more lenses. The lens member 430 may be disposed under the pattern forming member 420. Alternatively, the lens member 430 may be disposed between the light source 410 and the pattern forming member 420. Alternatively, when the lens member 430 is provided as two or more lenses, the pattern forming member 420 may be disposed between the two or more lenses.

The lens member 430 may adjust the focus for light emitted from the light irradiation unit 400, or the direction of the light. In addition, the lens member 430 may adjust the emitted light to propagate as a parallel ray. Alternatively, the lens member 430 may adjust the emitted light to spread out from the light irradiation unit 400. Alternatively, the lens member 430 may selectively adjust the emitted light to spread out or propagate as a parallel ray.

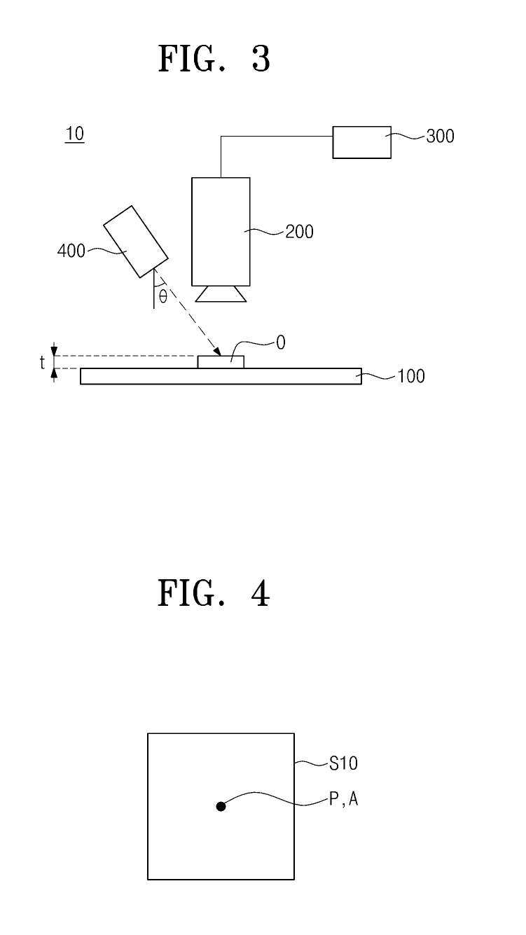

FIG. 3 is a schematic view illustrating a state in which light is emitted to an object to be examined which is disposed on a support. FIG. 4 is a plan view illustrating the object of FIG. 3.

Referring to FIGS. 1 to 4, the light irradiation unit 400 is disposed in a set location relative to the support 100 to emit light to the object O. The emitted light forms the examination pattern A on the object O. The image capturing member 200 is disposed in a set location relative to the light irradiation unit 400 and the support 100 to capture an image of an upper surface of the object O. The object O may have a standard thickness. When the object O disposed on the support 100 has the standard thickness, the examination pattern A is formed in a set location P.

The control member 300 examines a location of the examination pattern A, based on the image captured by the image capturing member 200. When the location of the examination pattern A on the object O is the set location P according to a result of the examination, the control member 300 determines that the object O has the standard thickness. In an example, when the examination pattern A is within a tolerance range from the set location P, the control member 300 may determine that the object O has the standard thickness or that the object O has an acceptable thickness. The tolerance range may be set to allow an error generated in a process adjusting relative locations between the light irradiation unit 400, the image capturing member 200, and the support 100. In an example, the tolerance range may be set to include the thickness tolerance range of the object O. In this case, a location of the examination pattern A that is within the tolerance range of the set location P may be described as having substantially the same location as P.

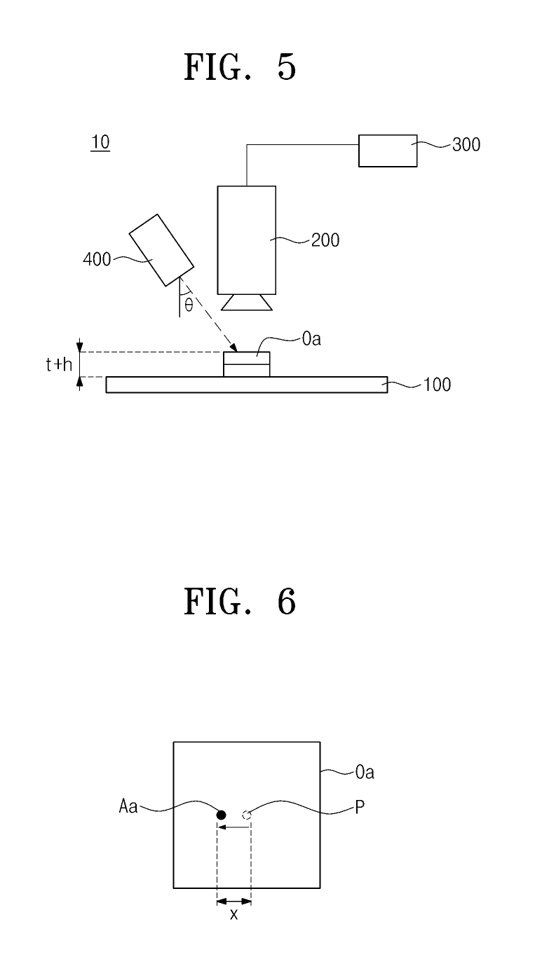

FIG. 5 is a schematic view illustrating a state in which light is emitted to an object to be examined which has a thickness greater than a standard thickness. FIG. 6 is a plan view illustrating the object of FIG. 5.

Referring to FIGS. 5 and 6, an object Oa is disposed on the support 100. The object Oa may have a thickness that is different from the standard thickness. For example, the object Oa may include two or more objects that are stacked on one another, so as to be detected as if the object Oa has a higher thickness. In an example, when the object Oa has a defective dimension, the thickness of the object Oa may be increased or decreased. In an example, when the object Oa is damaged, the thickness of the object Oa may be decreased.

The light irradiation unit 400 is disposed in the set location relative to the support 100 to emit light to the object Oa, as illustrated in FIG. 3. The image capturing member 200 is disposed in the set location relative to the light irradiation unit 400 and the support 100 to capture an image of the object Oa, as illustrated in FIG. 3. When a thickness of the object Oa changes, a location of an examination pattern Aa changes. When the thickness of the object O is increased, the examination pattern Aa formed on the object Oa moves toward the light irradiation unit 400. Specifically, the formula below shows the relationship between the horizontal direction movement distance x of the examination pattern Aa, the height increment h of the object Oa, and the inclination angle θ of irradiation light.

x=h*tan θ [Formula 1]

When the thickness of the object Oa is decreased, the examination pattern Aa formed on the object Oa moves away from the light irradiation unit 400 according to a relationship that is similar to Formula 1.

The control member 300 examines a location of the examination pattern Aa, based on the image captured by the image capturing member 200. When the location of the examination pattern Aa is out of a set value or value range from the set location P, the control member 300 determines that the thickness of the object Oa is abnormal or fails to meet the specification.

According to an embodiment of the inventive concept, a variation in the thickness of the object Oa may be sensed by using a two-dimensional image capturing member for capturing an image of a plane, like the image capturing member 200.

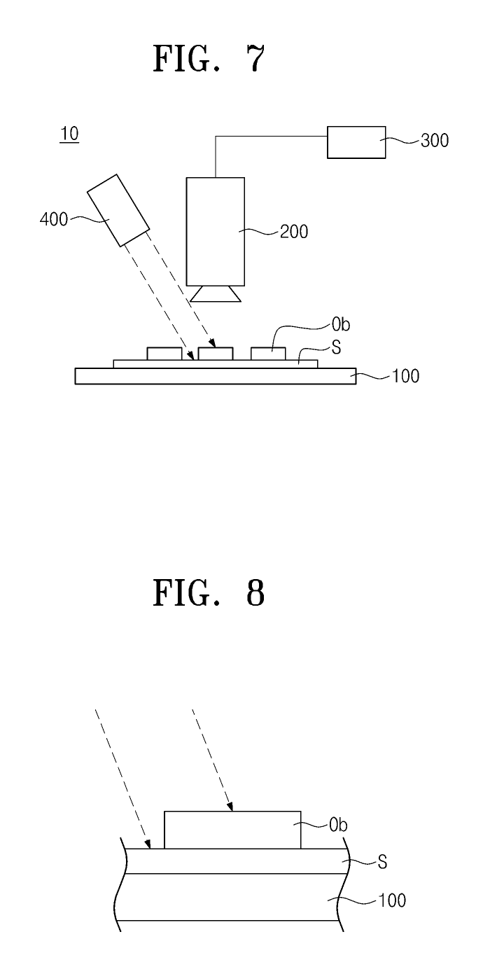

FIG. 7 is a schematic view illustrating an examination apparatus in which an object to be examined is disposed on an auxiliary support.

Referring to FIG. 7, an object Ob to be examined and an auxiliary support S may be disposed on the support 100. The object Ob disposed on the auxiliary support S may be put in and taken out of the examination apparatus 10. A plurality of objects Ob may be provided on the auxiliary support S. For example, when the objects Ob are semiconductor devices, the auxiliary support S may be a tray. The semiconductor devices disposed on the tray may be put in the examination apparatus 10 and be examined.

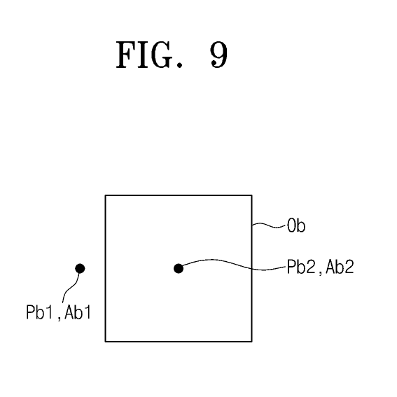

FIG. 8 is a schematic view illustrating a state in which light is emitted to an auxiliary support and an object to be examined. FIG. 9 is a plan view illustrating the auxiliary support and the object of FIG. 8.

Referring to FIGS. 8 and 9, the light irradiation unit 400 is disposed in the set location relative to the support 100 to obliquely emit light to the object Ob. The image capturing member 200 is disposed in the set location relative to the light irradiation unit 400 and the support 100 to capture an image of the object Ob.

Examination patterns Ab1 and Ab2 are formed on the auxiliary support S and the object Ob, respectively, by the emitted light. Specifically, light emitted to the auxiliary support S forms a first examination pattern Ab1 on the auxiliary support S. Light emitted to the object Ob forms a second examination pattern Ab2 on the object Ob. The light forming the first examination pattern Ab1 and the light forming the second examination pattern Ab2 propagate in parallel to each other with a set distance therebetween.

The control member 300 examines a relative location of the second examination pattern Ab2 to the first examination pattern Ab1, based on an image captured by the image capturing member 200. When the auxiliary support S disposed on the support 100 has a standard thickness, the first examination pattern Ab1 is formed in a first set location Pb1. When the object Ob disposed on the auxiliary support S has a standard thickness, the second examination pattern Ab2 is formed in a second set location Pb2. The relative location of the second examination pattern Ab2 to the first examination pattern Ab1 is constant when the auxiliary support S and the object Ob have the standard thicknesses.

When the relative location of the second examination pattern Ab2 to the first examination pattern Ab1 is a set value according to an examination result, the control member 300 determines that the object Ob has the standard thickness. In an example, when the relative location of the second examination pattern Ab2 is within a tolerance range from the set value, the control member 300 may determine that the object Ob has the standard thickness or that the object Ob has an acceptable thickness. The tolerance range may be set to allow an error generated in a process adjusting relative locations between the light irradiation unit 400, the image capturing member 200, and the support 100. In an example, the tolerance range may be set to include a thickness tolerance range of the object Ob.

When the first examination pattern Ab1 is disposed in the first set location Pb1 according to an examination result, the control member 300 may determine that the auxiliary support S has the standard thickness. In an example, when the first examination pattern Ab1 is within a tolerance range from the first set location Pb1, the control member 300 may determine that the auxiliary support S has the standard thickness or an acceptable thickness. The tolerance range may be set to allow an error generated in a process adjusting relative locations between the light irradiation unit 400, the image capturing member 200, and the support 100. In an example, the tolerance range may be set to include a thickness tolerance range of the auxiliary support S.

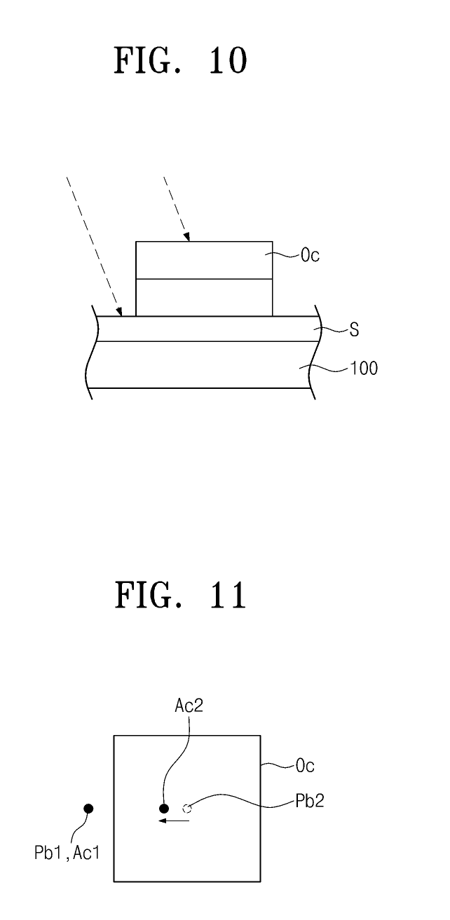

FIG. 10 is a schematic view illustrating a state in which light is emitted to an auxiliary support and an object to be examined which has a thickness greater than a standard thickness. FIG. 11 is a plan view illustrating the auxiliary support and the object of FIG. 10.

Referring to FIGS. 10 and 11, an object Oc is disposed on the auxiliary support S. The object Oc may have a thickness that is different from the standard thickness. Since the reason that the thickness of the object Oc is different from the standard thickness is the same as the reason that the thickness of the object Oa illustrated in FIGS. 5 and 6 is different from the standard thickness, a description thereof will be omitted.

The light irradiation unit 400 is disposed in the set location relative to the support 100 to emit light to the auxiliary support S and the object Oc, as illustrated in FIG. 8. The image capturing member 200 is disposed in the set location relative to the light irradiation unit 400 and the support 100 to capture an image of the auxiliary support S and the object Oc, as illustrated in FIG. 8.

When the thickness of the object Oc changes, a location of a second examination pattern Ac2 changes. When the thickness of the object Oc is increased, the second examination pattern Ac2 formed on the object Oc moves to the light irradiation unit 400. When the thickness of the object Oc is decreased, the second examination pattern Ac2 formed on the object Oc moves away from the light irradiation unit 400.

The control member 300 examines locations of a first examination pattern Ac1 and the second examination pattern Ac2, based on the image captured by the image capturing member 200. When a relative location of the second examination pattern Ac2 to the first examination pattern Ac1 is out of a set value or range of values, the control member 300 determines that the thickness of the object Oc is abnormal.

When the first examination pattern Ac1 is formed in the first set location Pb1, the control member 300 determines that the auxiliary support S has the standard thickness.

According to an embodiment of the inventive concept, a variation in the thickness of the object Oc may be sensed and/or examined while the object Oc is disposed on the auxiliary support S.

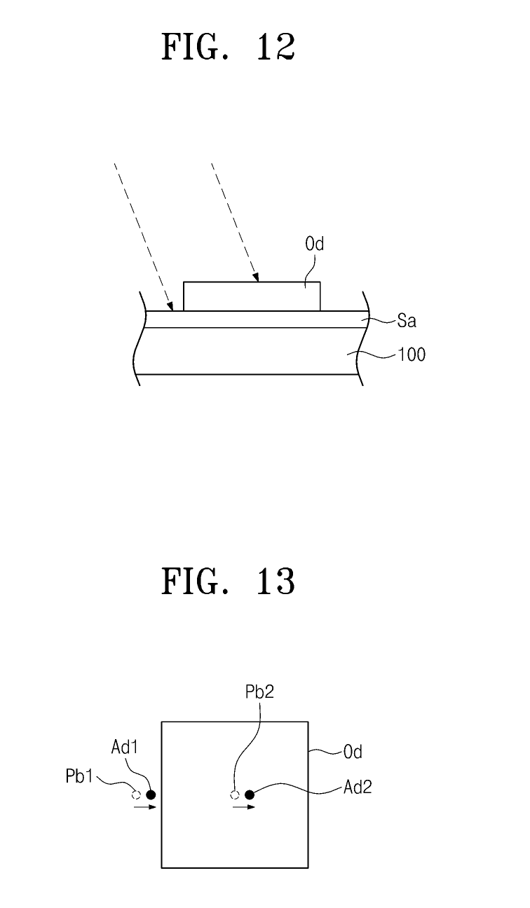

FIG. 12 is a schematic view illustrating a state in which light is emitted to an object to be examined and an auxiliary support having a thickness smaller than a standard thickness. FIG. 13 is a plan view illustrating the auxiliary support and the object of FIG. 12.

Referring to FIGS. 12 and 13, an auxiliary support Sa may have a thickness that is different from the standard thickness. For example, when the auxiliary support Sa is a tray, a central region of the tray may sag. Thus, when a thickness from the support 100 to the upper surface of the tray is measured as the tray thickness, the tray thickness may be recognized to be small in the sagged region. In another example, when the tray is twisted, the thickness of the tray may be recognized to be uneven.

The light irradiation unit 400 is disposed in the set location relative to the support 100 to emit light to the auxiliary support Sa and the object Od, as illustrated in FIG. 8. The image capturing member 200 is disposed in the set location relative to the light irradiation unit 400 and the support 100 to capture an image of the auxiliary support Sa and the object Od, as illustrated in FIG. 8.

When the thickness of the auxiliary support Sa changes, a location of a first examination pattern Ad1 changes. When the thickness of the auxiliary support Sa is increased, the first examination pattern Ad1 formed on the auxiliary support Sa moves toward the light irradiation unit 400. When the thickness of the auxiliary support Sa is decreased, the first examination pattern Ad1 formed on the auxiliary support Sa moves away from the light irradiation unit 400. A second examination pattern Ad2 formed on the object Od moves in the same direction as that of the first examination pattern Ad1 according to the thickness change of the auxiliary support Sa.

When a relative location of the second examination pattern Ad2 to the first examination pattern Ad1 is a set value according to an examination result, the control member 300 determines that the object Od has the standard thickness. In another embodiment, when the relative location of the second examination pattern Ad2 is within a tolerance range from the set value, the control member 300 may determine that the object Od has the standard thickness or an acceptable thickness. Since descriptions of the tolerance range setting are the same as those of FIGS. 8 and 9, a description thereof will be omitted here.

When the first examination pattern Ad1 is disposed out of the first set location Pb1 or out of its tolerance range from the set location Pb1 according to an examination result, the control member 300 may determine that the thickness of the auxiliary support Sa is abnormal. In an example, when the first examination pattern Ad1 is within a tolerance range from the first set location Pb1, the control member 300 may determine that the auxiliary support Sa has the standard thickness or an acceptable thickness. Since descriptions of the tolerance range setting are the same as those of FIGS. 8 and 9, a description thereof will be omitted here.

According to an embodiment of the inventive concept, a variation in the thickness of the auxiliary support Sa may be detected.

In addition, according to an embodiment of the inventive concept, a thickness of the object Od disposed on the auxiliary support Sa may be detected. In an exemplary embodiment, the thickness of the object Od may be detected even though the object is disposed on an auxiliary support Sa having an abnormal thickness.

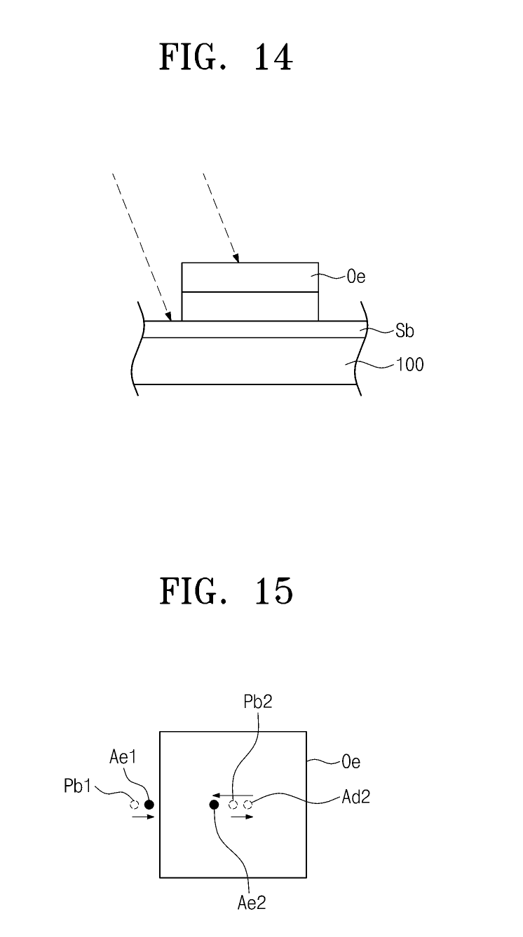

FIG. 14 is a schematic view illustrating a state in which light is emitted to an auxiliary support having a thickness smaller than a standard thickness, and an object to be examined which has a thickness greater than a standard thickness. FIG. 15 is a plan view illustrating the auxiliary support and the object of FIG. 14.

Referring to FIGS. 14 and 15, the light irradiation unit 400 is disposed in the set location relative to the support 100 to emit light to an auxiliary support Sb and an object Oe to be examined as illustrated in FIG. 8, and as described regarding FIG. 8. The image capturing member 200 is disposed in the set location relative to the light irradiation unit 400 and the support 100 to capture an image of the auxiliary support Sb and the object Oe as illustrated in FIG. 8, and as described regarding FIG. 8.

When a thickness of the auxiliary support Sb changes, a location of a first examination pattern Ae1 changes. When the thickness of the auxiliary support Sb is increased, the first examination pattern Ae1 formed on the auxiliary support Sb moves toward the light irradiation unit 400. When the thickness of the auxiliary support Sb is decreased, the first examination pattern Ae1 formed on the auxiliary support Sb moves away from the light irradiation unit 400.

A location of a second examination pattern Ae2 formed on the object Oe moves in a manner obtained by combining the descriptions regarding FIGS. 11 and 13. Thus, a relative location of the second examination pattern Ae2 to the first examination pattern Ae1 changes.

The control member 300 examines locations of the first examination pattern Ae1 and the second examination pattern Ae2, based on the image captured by the image capturing member 200. When the relative location of the second examination pattern Ae2 to the first examination pattern Ae1 is out of a set value, the control member 300 determines that a thickness of the object Oe is abnormal or out-of-specification.

When the first examination pattern Ae1 is disposed out of the first set location Pb1 according to an examination result, the control member 300 may determine that the thickness of the auxiliary support Sb is abnormal or out-of-specification. In another example, when the first examination pattern Ae1 is within a tolerance range from the first set location Pb1, the control member 300 may determine that the object Oe has the standard thickness or an acceptable thickness.

According to an embodiment of the inventive concept, an examination apparatus may determine whether the thicknesses of the object Oe and the auxiliary support Sb are abnormal/out-of-specification or normal/standard/acceptable.

Although FIGS. 7-15 describe a method of determining whether a thickness of an object is abnormal/out-of-specification or normal/standard/acceptable by capturing an examination pattern on the object and an examination pattern on an auxiliary support, the same process may be used to by capturing an examination pattern on the object and an examination pattern on the non-auxiliary support (such as support 100). For example, by comparing an expected distance between points formed in an image as a result of a pattern of light that is formed on the support 100 and on an object such as a semiconductor chip or package placed on the support to an actual distance appearing in a captured image, it can be determined whether a semiconductor device placed on the support has an acceptable/standard thickness or abnormal/out-of-specification.

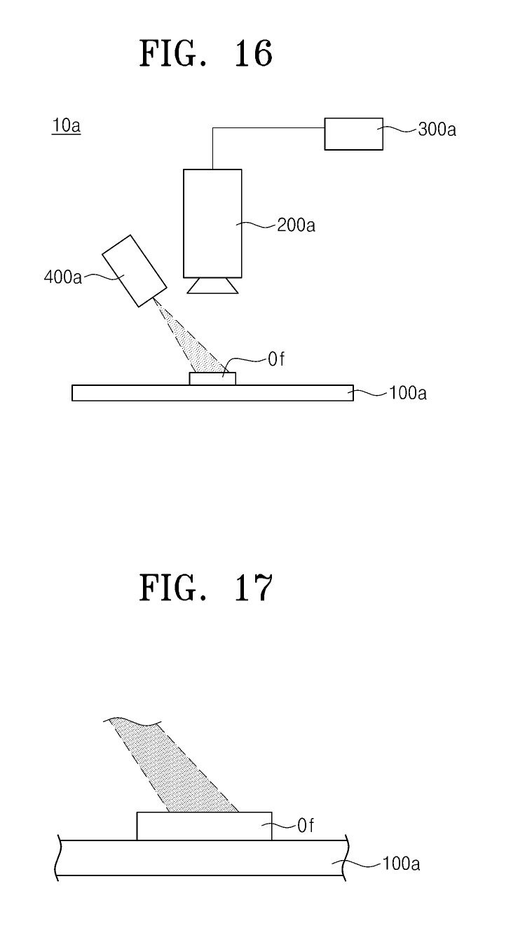

FIG. 16 is a schematic view illustrating an examination apparatus that emits light, according to an embodiment.

Referring to FIG. 16, an examination apparatus 10a emits light such that the light spreads away from a light irradiation unit 400a, thereby examining an object Of.

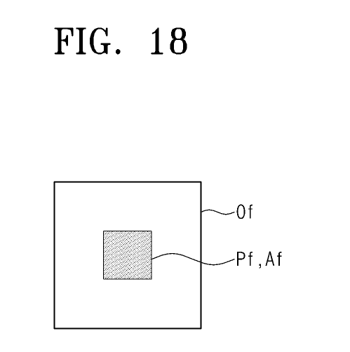

FIG. 17 is a schematic view illustrating a state in which light is emitted to an object to be examined which is disposed on a support. FIG. 18 is a plan view illustrating the object of FIG. 17.

Referring to FIGS. 16 to 18, the light irradiation unit 400a is disposed in a set location relative to a support 100a to emit light to the object Of. An examination pattern Af formed on the object Of has a predetermined area and is formed in a set location. An image capturing member 200a is disposed in a set location relative to the light irradiation unit 400a and the support 100a to capture an image of the object Of.

A control member 300a examines the examination pattern Af, based on the image captured by the image capturing member 200a. At this point, the control member 300a may examine whether the examination pattern Af is disposed in a location of a set pattern Pf. When a location of the examination pattern Af on the object Of is the location of the set pattern Pf according to a result of the examination, the control member 300a determines that the object Of has a standard thickness.

Alternatively, the control member 300a may examine whether an area of the examination pattern Af is the same as an area of the set pattern Pf. When the area of the examination pattern Af on the object Of is the area of the set pattern Pf according to a result of the examination, the control member 300a determines that the object Of has the standard thickness.

Alternatively, the control member 300a may simultaneously check the location and area of the examination pattern Af.

When the control member 300a determines the location or area of the examination pattern Af, a tolerance range may be reflected therein to determine the standard thickness or acceptable thickness similarly to the descriptions of other embodiments above.

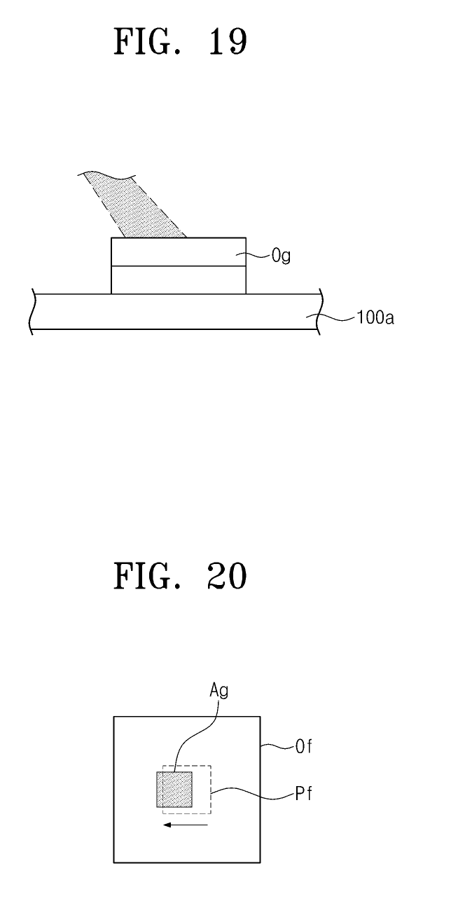

FIG. 19 is a schematic view illustrating a state in which light is emitted to an object to be examined which has a thickness greater than a standard thickness. FIG. 20 is a plan view illustrating the object of FIG. 19.

Referring to FIGS. 19 and 20, the light irradiation unit 400a is disposed in the set location relative to the support 100a to emit light to an object Og to be examined as illustrated in FIG. 16, and as described regarding FIG. 16. The image capturing member 200a is disposed in the set location relative to the light irradiation unit 400a and the support 100a to capture an image of the object Og as illustrated in FIG. 16, and as described regarding FIG. 16. When a thickness of the object Og changes, a location and an area of the examination pattern Ag change. When the thickness of the object Og is increased, the examination pattern Ag formed on the object Og moves from the location of the set pattern Pf toward the light irradiation unit 400a, and the area of the examination pattern Ag becomes smaller than the area of the set pattern Pf. When the thickness of the object Og is decreased, the examination pattern Ag formed on the object Og moves from the location of the set pattern Pf in the direction away from the light irradiation unit 400a, and the area of the examination pattern Ag becomes greater than the area of the set pattern Pf.

The control member 300a examines the examination pattern Ag, based on the image captured by the image capturing member 200a. At this point, when the examination pattern Ag is disposed out of the set pattern Pf, the control member 300a may determine that the thickness of the object Og is abnormal or out-of-specification.

Alternatively, the control member 300a may examine whether the area of the examination pattern Ag is a set area. When the area of the examination pattern Ag on the object Og is different from the area of the set pattern Pf according to a result of the examination, the control member 300a determines that the thickness of the object Og is abnormal or out-of-specification.

Alternatively, the control member 300a may simultaneously check the location and area of the examination pattern Ag.

When the control member 300a determines the location or area of the examination pattern Ag, a tolerance range may be reflected therein. Therefore, when the location or the area of the examination pattern Ag is within the tolerance, the control member 300a may determine that the thickness of the object Og is acceptable.

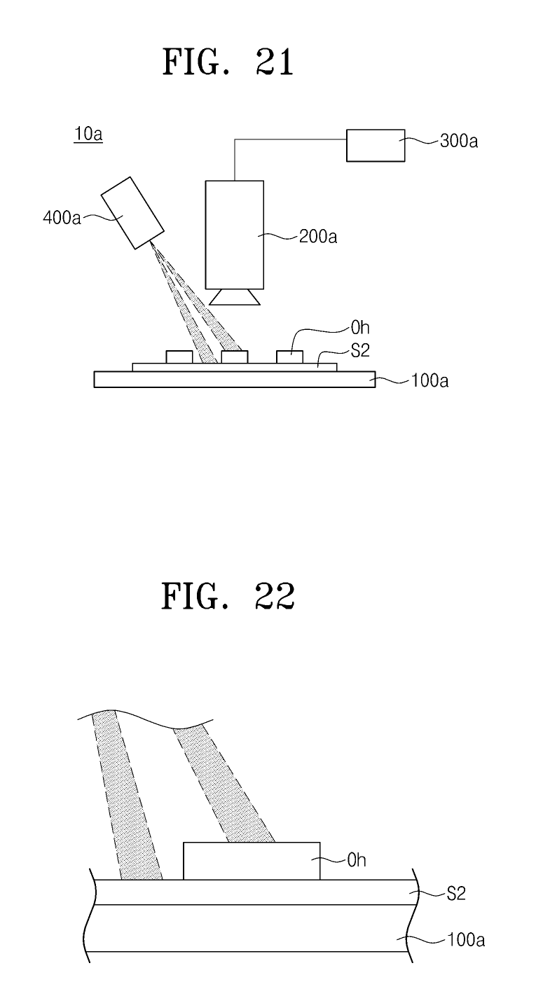

FIG. 21 is a schematic view illustrating an examination apparatus in which an object to be examined is disposed on an auxiliary support.

Referring to FIG. 21, an object Oh to be examined and an auxiliary support S2 may be disposed on the support 100a.

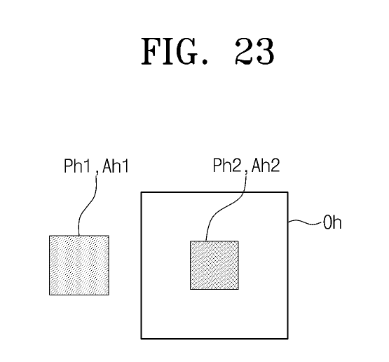

FIG. 22 is a schematic view illustrating a state in which light is emitted to an auxiliary support and an object to be examined. FIG. 23 is a plan view illustrating the auxiliary support and the object of FIG. 22.

The light irradiation unit 400a is disposed in the set location relative to the support 100a to emit light to the object Oh. The image capturing member 200a is disposed in the set location relative to the light irradiation unit 400a and the support 100a to capture an image of the object Oh and the auxiliary support S2.

Examination patterns Ah1 and Ah2 are formed on the auxiliary support S2 and the object Oh, respectively, by the emitted light. For example, light emitted to the auxiliary support S2 forms a first examination pattern Ah1 on the auxiliary support S2. Light emitted to the object Oh forms a second examination pattern Ah2 on the object Oh. The light forming the first examination pattern Ah1 and the light forming the second examination pattern Ah2 propagate with a set angle therebetween.

The control member 300a examines the first examination pattern Ah1 and the second examination pattern Ah2, based on the image captured by the image capturing member 200a. When the auxiliary support S2 disposed on the support 100a has a standard thickness, the first examination pattern Ah1 has a set area and is formed in a set location. When the object Oh and the auxiliary support S2 have standard thicknesses, the second examination pattern Ah2 has a set area and is formed in a set location. A relative location of the second examination pattern Ah2 to the first examination pattern Ah1 is constant or has a preset distance when the auxiliary support S2 and the object Oh have the standard thicknesses.

The control member 300a may determine whether thicknesses of the auxiliary support S2 and the object Oh are normal/acceptable or abnormal/out-of-specification, by using locations of the first examination pattern Ah1 and the second examination pattern Ah2. For example, when the relative location of the second examination pattern Ah2 to the first examination pattern Ah1 is a set value according to an examination result, the control member 300a may determine that the object Oh has the standard thickness. When the first examination pattern Ah1 is disposed in a location of a first set pattern Ph1 according to an examination result, the control member 300a may determine that the auxiliary support S2 has the standard thickness.

The control member 300a may determine whether the thicknesses of the auxiliary support S2 and the object Oh are normal/acceptable or abnormal/out-of-speciation, by using areas of the first examination pattern Ah1 and the second examination pattern Ah2. For example, when the area of the first examination pattern Ah1 is an area of the first set pattern Ph1, and the area of the second examination pattern Ah2 is an area of the second set pattern Ph2, the control member 300a may determine that the auxiliary support S2 and the object Oh have the standard thicknesses.

The control member 300a may determine the thicknesses of the auxiliary support S2 and the object Oh, by using the area and/or the location of the first examination pattern Ah1 and the area and/or the location of the second examination pattern Ah2.

The control member 300a may reflect a tolerance in the area and/or the location of the first examination pattern Ah1 to determine the thickness of the auxiliary support S2. The control member 300a may reflect a tolerance in the area and/or the location of the second examination pattern Ah2 to determine the thickness of the object Oh.

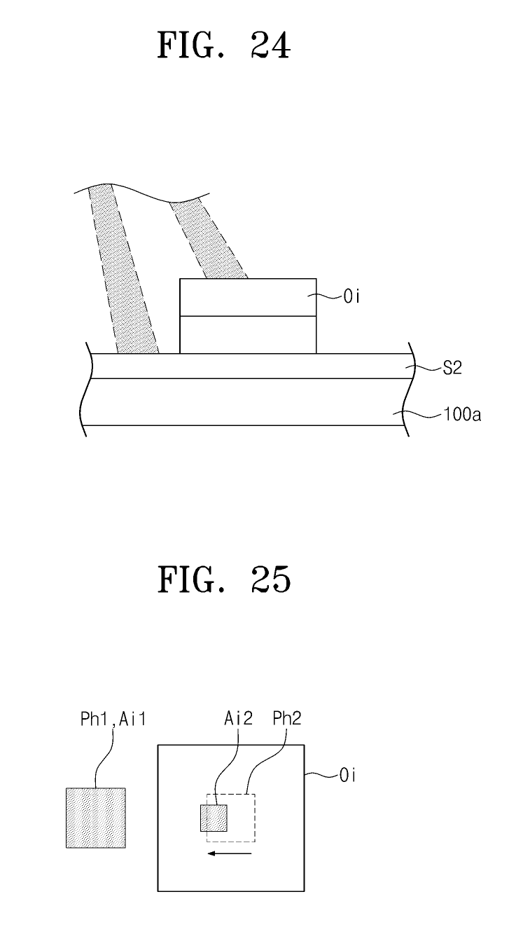

FIG. 24 is a schematic view illustrating a state in which light is emitted to an auxiliary support and an object to be examined which has a thickness greater than a standard thickness. FIG. 25 is a plan view illustrating the auxiliary support and the object of FIG. 24.

Referring to FIGS. 24 and 25, an object Oi disposed on the auxiliary support S2 may have a thickness that is different from the standard thickness. Since the reason that the thickness of the object Oi is different from the standard thickness is the same as the reason that the thickness of the object Oa illustrated in FIGS. 5 and 6 is different from the standard thickness, a description thereof will be omitted here.

The light irradiation unit 400a is disposed in the set location relative to the support 100a to emit light to the auxiliary support S2 and the object Oi, as illustrated in FIG. 21 and described regarding FIG. 21. The image capturing member 200a is disposed in the set location relative to the light irradiation unit 400a and the support 100a to capture an image of the auxiliary support S2 and the object Oi, as illustrated in FIG. 21 and described regarding FIG. 21.

When the thickness of the object Oi changes, the location and the area of a second examination pattern Ai2 change. When the thickness of the object Oi is increased, the second examination pattern Ai2 formed on the object Oi moves toward the light irradiation unit 400a, and the area thereof is decreased. When the thickness of the object Oi is decreased, the second examination pattern Ai2 formed on the object Oi moves away from the light irradiation unit 400a, and the area thereof is increased.

The control member 300a examines a first examination pattern Ai1 and the second examination pattern Ai2, based on the image captured by the image capturing member 200a.

The control member 300a may determine whether the thicknesses of the auxiliary support S2 and the object Oi are normal/standard/acceptable or abnormal/out-of-specification, by using locations of the first examination pattern Ai1 and the second examination pattern Ai2. For example, when a relative location of the second examination pattern Ai2 to the first examination pattern Ai1 is out of a set value according to an examination result, the control member 300a may determine that the thickness of the object Oi is abnormal or out-of-specification. When the first examination pattern Ai1 is disposed in the location of the first set pattern Ph1 according to an examination result, the control member 300a determines that the auxiliary support S2 has the standard thickness.

The control member 300a may determine whether the thicknesses of the auxiliary support S2 and the object Oi are acceptable or abnormal/out-of-specification, by using areas of the first examination pattern Ai1 and the second examination pattern Ai2. For example, when the area of the first examination pattern Ai1 is the area of the first set pattern Ph1, and the area of the second examination pattern Ai2 is different from the area of the second set pattern Ph2, the control member 300a determines that the auxiliary support S2 has the standard thickness, and the thickness of the object Oi is abnormal or out-of-specification.

The control member 300a may determine the thicknesses of the auxiliary support S2 and the object Oi, by using the area and/or the location of the first examination pattern Ai1 and the area and/or the location of the second examination pattern Ai2.

The control member 300a may reflect a tolerance in the area and/or the location of the first examination pattern Ai1, or the area and/or the location of the second examination pattern Ai2 in determining whether the thicknesses of the auxiliary support S2 and the object Oi are acceptable or out-of-specification.

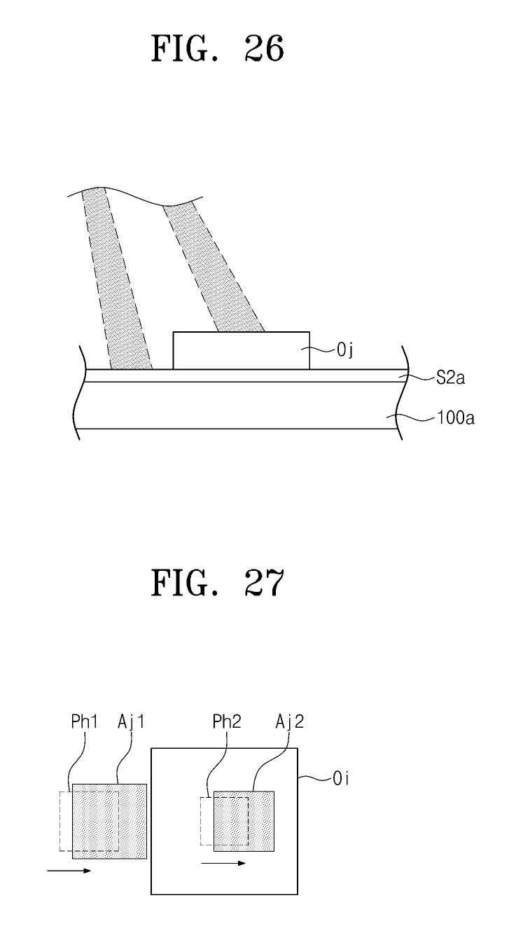

FIG. 26 is a schematic view illustrating a state in which light is emitted to an object to be examined and an auxiliary support having a thickness smaller than a standard thickness. FIG. 27 is a plan view illustrating the auxiliary support and the object of FIG. 26.

Referring to FIGS. 26 and 27, an auxiliary support S2a may have a thickness that is different from the standard thickness. Since the reason that the thickness of the auxiliary support S2a is different from the standard thickness is the same as the reason that the thickness of the auxiliary support Sa illustrated in FIGS. 12 and 13 is different from the standard thickness, a description thereof will be omitted here.

The light irradiation unit 400a is disposed in the set location relative to the support 100a to emit light to the auxiliary support S2a and an object Oj, as similarly illustrated in FIG. 21. The image capturing member 200a is disposed in the set location relative to the light irradiation unit 400a and the support 100a to capture images of the auxiliary support S2a and the object Oj, as similarly illustrated in FIG. 21.

When the thickness of the auxiliary support S2a changes, the location and the area of a first examination pattern Aj1 change. When the thickness of the auxiliary support S2a is increased, the first examination pattern Aj1 formed on the auxiliary support S2a moves from the location of the first set pattern Ph1 toward the light irradiation unit 400a, and the area of the first examination pattern Aj1 becomes smaller than the area of the first set pattern Ph1. When the thickness of the auxiliary support S2a is decreased, the first examination pattern Aj1 formed on the auxiliary support S2a moves from the location of the first set pattern Ph1 in the direction away from the light irradiation unit 400a, and the area of the first examination pattern Aj1 becomes greater than the area of the first set pattern Ph1. A second examination pattern Aj2 formed on the object Oj moves in the same direction as that of the first examination pattern Aj1 from the second set pattern Ph2, and the area of the second examination pattern Aj2 changes in the same ratio as that of the first examination pattern Aj1.

The relative location of the second examination pattern Aj2 to the first examination pattern Aj1 changes. For example, when the thickness of the auxiliary support S2a is increased, the first examination pattern Aj1 and the second examination pattern Aj2 come closer to each other. When the thickness of the auxiliary support S2a is decreased, the first examination pattern Aj1 and the second examination pattern Aj2 move away from each other. A variation in the area of the first examination pattern Aj1 or the second examination pattern Aj2 may correspond to the square of a variation in a distance between the first examination pattern Aj1 and the second examination pattern Aj2.

When the first examination pattern Aj1 and the second examination pattern Aj2 are the same in movement direction and movement length according to an examination result, the control member 300a may determine that the object Oj has the standard thickness. Alternatively, when the first examination pattern Aj1 and the second examination pattern Aj2 are the same in area variation according to an examination result, the control member 300a may determine that the object Oj has the standard thickness. Alternatively, when a variation in the distance between the first examination pattern Aj1 and the second examination pattern Aj2 corresponds to the square root of a variation in the area of the first examination pattern Aj1, the control member 300a may determine that the object Oj has the standard thickness. When a variation in the distance between the first examination pattern Aj1 and the second examination pattern Aj2 corresponds to the square root of a variation in the area of the second examination pattern Aj2, the control member 300a may determine that the object Oj has the standard thickness.

When the first examination pattern Aj1 is disposed out of the location of the first set pattern Ph1, the control member 300a may determine that the thickness of the auxiliary support S2a is abnormal or out-of-specification. When the area of the first examination pattern Aj1 is different from the area of the first set pattern Ph1, the control member 300a may determine that the thickness of the auxiliary support S2a is abnormal or out-of-specification.

The control member 300a may reflect a tolerance in the area and/or the location of the first examination pattern Aj1, the area and/or the location of the second examination pattern Aj2, and/or the distance between the first examination pattern Aj1 and the second examination pattern Aj2.

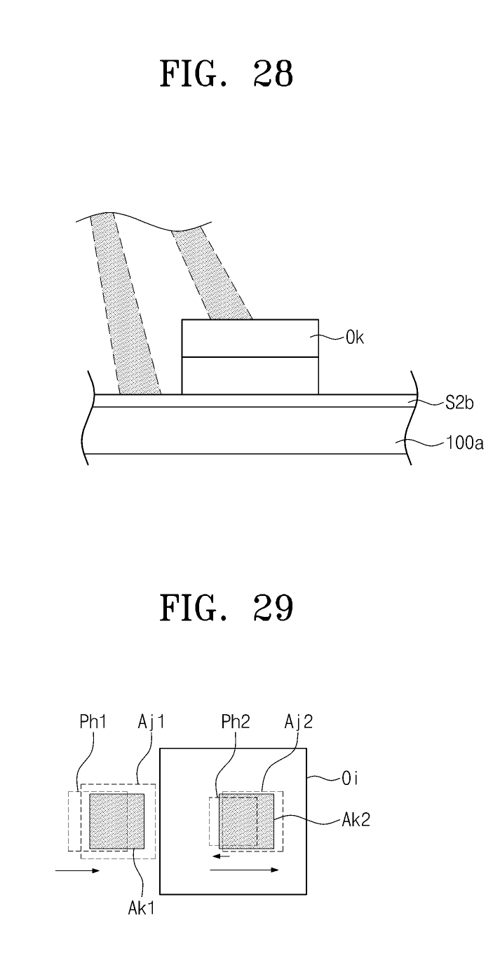

FIG. 28 is a schematic view illustrating a state in which light is emitted to an auxiliary support having a thickness smaller than a standard thickness, and an object to be examined which has a thickness greater than a standard thickness. FIG. 29 is a plan view illustrating the auxiliary support and the object of FIG. 28.

Referring to FIGS. 28 and 29, the light irradiation unit 400a is disposed in the set location relative to the support 100a to emit light to an auxiliary support S2b and an object Ok to be examined, as similarly illustrated in FIG. 21. The image capturing member 200a is disposed in the set location relative to the light irradiation unit 400a and the support 100a to capture an image of the auxiliary support S2b and the object Ok, as illustrated in FIG. 21.

When thicknesses of the auxiliary support S2b changes, the location and the area of a first examination pattern Ak1 change as a similar manner illustrated in FIGS. 26 and 27.

When the thicknesses of the auxiliary support S2b and/or the object Ok change, a location and an area of a second examination pattern Ak2 are also changed as a similar manner illustrated in FIGS. 24 through 27.

When the first examination pattern Ak1 and the second examination pattern Ak2 are different in movement direction or movement amount according to an examination result, the control member 300a may determine that the thickness of the object Ok is abnormal or out-of-specification. When the first examination pattern Ak1 and the second examination pattern Ak2 are different in area variation according to an examination result, the control member 300a may determine that the thickness of the object Ok is abnormal or out-of-specification. Alternatively, when a variation in a distance between the first examination pattern Ak1 and the second examination pattern Ak2 is different from the square root of a variation in the area of the first examination pattern Ak1, the control member 300a may determine that the thickness of the object Ok is abnormal or out-of-specification. When a variation in the distance between the first examination pattern Ak1 and the second examination pattern Ak2 is different from the square root of a variation in the area of the second examination pattern Ak2, the control member 300a may determine that the thickness of the object Ok is abnormal or out-of-specification.

When the first examination pattern Ak1 is disposed out of a set location, the control member 300a may determine that the thickness of the auxiliary support S2b is abnormal or out-of-specification. When the area of the first examination pattern Ak1 is different from a set area, the control member 300a may determine that the thickness of the auxiliary support S2b is abnormal or out-of-specification.

The control member 300a may reflect a tolerance in the area and/or the location of the first examination pattern Ak1, the area and/or the location of the second examination pattern Ak2, and/or the distance between the first examination pattern Ak1 and the second examination pattern Ak2 in determining the thicknesses of the auxiliary support S2b and the object Ok.

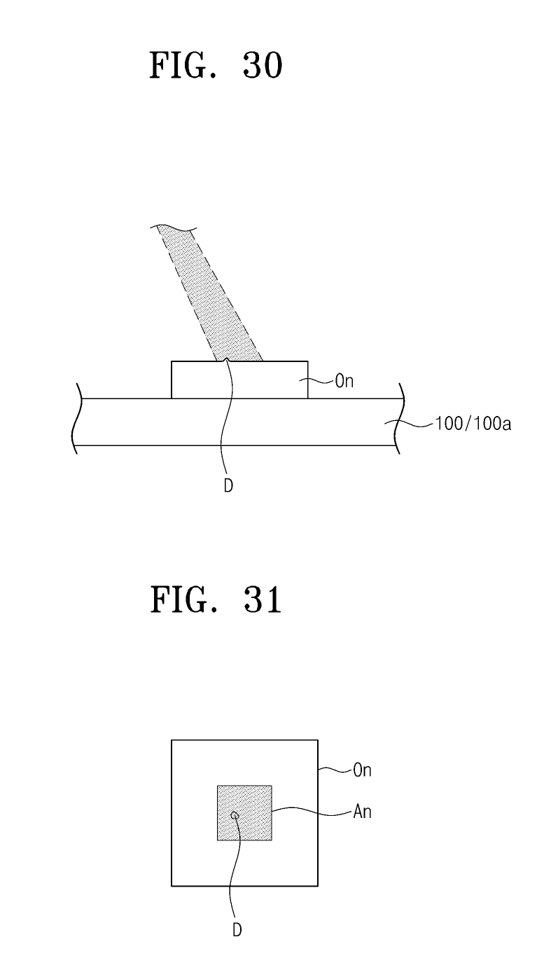

As discussed above, the examine apparatus may be used to determine other features of an object, such as, for example, a foreign substance, or unexpected material on a surface of a semiconductor device. As shown in FIGS. 30 and 31, for example, an object On, such as a semiconductor device, has a bump D that may be formed, for example, from a foreign substance. When an examination pattern An is captured by an image capturing member and analyzed by a control member, the examination pattern has a spot D that appears, as a result of the foreign substance. As a result, the examination pattern Am does not match an expected examination pattern that corresponds to a standard device, and a defect or other abnormality can be detected.

According to an embodiment of the disclosure, the objects to be examined may include semiconductor chips. For example, a plurality of semiconductor circuits may be formed on a substrate (e.g., a wafer) by various photolithography processes. The semiconductor circuits may include, for example, ASIC or memory circuits including a RAM, a ROM, or a flash memory, or other volatile or non-volatile memory circuits or logic circuits. The substrate may then be divided into separate semiconductor chips. The semiconductor chips may be examined to determine whether they have proper shapes and thicknesses, and/or whether they have any defects, by one or more of the embodiments described with reference to FIGS. 1 through 31. The chips that are determined to have proper shapes/sizes, and are free of defects may be packaged into a semiconductor package, for example, that includes a package substrate including external connection terminals, and a resin or other molded material that covers the semiconductor chip. In another embodiment, prior to packaging, semiconductor chips may be stacked, and each stack of semiconductor chips may be examined using the examination apparatus described herein. Chips or stacks of chips that are determined to have improper shapes/sizes or to include defects may be discarded.

According to another embodiment, a semiconductor chip is packaged into a semiconductor package prior to being examined. After the semiconductor chip is packaged, the package is examined to determine whether the package has a proper shape, thickness, etc., and is free of defects, by one or more of the embodiments described with reference to FIGS. 1 through 31. The packages that are determined to have proper shapes/sizes and to be free of defects (e.g., packages that comply with a standard) are equipped into electronic devices. The electronic devices may include, for example, a consumer electronic device, a computer, or a mobile device including a cell phone, a tablet pc, a laptop, etc. Packages that are determined to have improper shapes/sizes or to include defects may be discarded.

The methods described herein may be particularly useful for objects such as semiconductor chips or semiconductor packages that are intended to have a flat upper surface, and whose entire upper surface need not be scanned to determine whether the semiconductor device is compliant with a standard.

According to an embodiment of the inventive concept, a variation in the thickness of an object to be examined can be sensed and/or examined. In the embodiments described above, it was described that one point or one area of an object or an auxiliary support is examined. However, multiple points or areas may be also examined to determine whether a thickness of an object or an auxiliary support is proper.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present disclosure.

What is claimed is:

1. An examination apparatus for examining a semiconductor device, the examination apparatus comprising:
a support on which the semiconductor device to be examined is disposed;
a light irradiation unit that obliquely emits light at a set angle to the support;
an image capturing member configured to capture an image of an upper surface of the support and an upper surface of the semiconductor device; and
a control member configured to sense, based on the image captured by the image capturing member, whether a height of the semiconductor device is substantially the same as a predetermined standard height by using the set angle and an examination pattern formed on the upper surface of the semiconductor device by the light.

2. The examination apparatus of claim 1, wherein the image capturing member is upwardly spaced a set distance from an upper surface of the semiconductor device to capture a planar image of the semiconductor device.

3. The examination apparatus of claim 1, wherein the light irradiation unit comprises:
a light source disposed in an upper part thereof to emit light; and
a pattern forming member disposed under the light source such that the examination pattern is formed by the light.

4. The examination apparatus of claim 1, wherein the light irradiation unit emits light such that the examination pattern is provided in plurality on the semiconductor device and a region adjacent to the semiconductor device, respectively.

5. The examination apparatus of claim 5, wherein the control member is configured to sense whether the height of the semiconductor device is substantially the same as the predetermined standard height, based on a first examination pattern formed in the region adjacent to the semiconductor device, a second examination pattern formed on the semiconductor device, and the set angle.

6. The examination apparatus of claim 5, wherein the light irradiation unit emits light to propagate as a parallel ray.

7. The examination apparatus of claim 1, wherein the support is an auxiliary support, and the control member is configured to sense whether the height of the semiconductor device is substantially the same as the predetermined standard height by using the set angle, the examination pattern formed on the upper surface of the semiconductor device by the light, and an examination pattern formed on the upper surface of the auxiliary support by the light.

8. The examination apparatus of claim 7, wherein whether the height of the semiconductor device is substantially the same as the predetermined standard height is determined based on a distance in a horizontal direction between the examination patterns formed on the upper surface of the semiconductor device by the light, and the examination pattern formed on the upper surface of the auxiliary support by the light.

9. A method of examining a semiconductor device, comprising:
disposing the semiconductor device on a support;
forming an examination pattern on a top surface of the semiconductor device by obliquely emitting light at a set angle to the semiconductor device; and
using an electronic image capture device, capturing an overhead image of the top surface of the semiconductor device, and using the examination pattern, the overhead image, and the set angle to determine whether a thickness of the semiconductor device corresponds to a standard thickness.

10. The method of claim 9, wherein a control member determines whether the thickness of the semiconductor device corresponds to the standard thickness by using a location of the examination pattern within the overhead image and a set location in which the examination pattern is formed in an overhead image when the thickness of the semiconductor device corresponds to the standard thickness.

11. The method of claim 9, wherein a control member determines whether the thickness of the semiconductor device corresponds to the standard thickness by using an area of the examination pattern and an area of a set pattern formed on the semiconductor device by the light when the thickness of the semiconductor device corresponds to a standard thickness.

12. The method of claim 9, wherein the semiconductor device is disposed on an auxiliary support disposed on the support.

13. The method of claim 12, wherein a first examination pattern is formed on the auxiliary support by the light, and a second examination pattern is formed on the semiconductor device by the light.

14. The method of claim 13, wherein whether the thickness of the semiconductor device corresponds to the standard thickness is determined using the set angle and a relative location of the second examination pattern to the first examination pattern.

15. The method of claim 13, wherein whether the thickness of the semiconductor device corresponds to the standard thickness is determined using a variation in an area of the first examination pattern and a variation in an area of the second examination pattern.

16. A method of manufacturing an electronic device, comprising:
forming circuit on a semiconductor substrate;
cutting the substrate into plurality of semiconductor chips;
packaging one of the chips into a semiconductor package;
examining the semiconductor package by using an examination apparatus; and
installing the semiconductor package into the electronic device,
wherein the examination apparatus comprises:
a support on which the semiconductor package is disposed,
a light irradiation unit emitting light obliquely to the support,
an image capturing device capturing an image of the semiconductor package and its surroundings, and
a control unit that examines whether a height of the semiconductor package is substantially the same as a predetermined standard height based on a location or area of the light on the support.

17. The method of claim 16, wherein the control unit examines whether the height of the semiconductor package is substantially the same as the predetermined standard height comparing a location in a horizontal direction of a light emitted on the semiconductor device to a predetermined location in the horizontal direction.

18. The method of claim 16, wherein the light irradiation unit emits two or more light patterns, a first of the light patterns emitted onto the semiconductor package, a second of the light patterns emitted on the surroundings, and the control unit examines whether the height of the semiconductor package is substantially the same as a predetermined standard height by comparing the first and the second light patterns.

19. The method of claim 18, wherein the first light pattern is formed from a light transmitted parallel to a light that forms the second light pattern.

20. The method of claim 16, wherein the light irradiation unit emits a spreading out light pattern.
